(19) United States
(12) Patent Application Publication
(10) Pub. No.: US 2025/0353477 A1
(43) Pub. Date: Nov. 20, 2025

(54) METHOD FOR OPERATING A BRAKING SYSTEM AND BRAKING SYSTEM

(71) Applicant: Robert Bosch GmbH, Stuttgart (DE)

(72) Inventors: Florian Haag, Ellhofen (DE); Markus Schuster, Helmstadt (DE); Martin Marquart, Ludwigsburg (DE); Nikolas Loeffelmann, Dielheim (DE)

(21) Appl. No.: 19/202,238

(22) Filed: May 8, 2025

(30) Foreign Application Priority Data
May 17, 2024 (DE) 10 2024 204 596.9

(51) Int. Cl. B60T 8/88; B60T 7/04

(52) U.S. Cl. CPC B60T 8/885; B60T 7/042; B60T 2270/404; B60T 2270/413; B60T 2270/82

(57) ABSTRACT

A method for operating a braking system in a vehicle. First calibration data are transmitted from a first sensor arranged on a brake pedal of the vehicle to a first braking product and/or second calibration data are transmitted from a second sensor arranged on the brake pedal of the vehicle to a second braking product. First and second sensor data are generated by the first and second sensors according to an actuation of the brake pedal by a user. The first and second sensor data are transmitted to the first and/or second braking product. Based on ascertaining that the first and the second braking products are present in the vehicle, the braking system is operated in a first operating state. Based on ascertaining that only the first braking product or only the second braking product is present, the braking system is operated in a second operating state.

### FIELD

The present invention relates to a method for operating a braking system and to a braking system.

### BACKGROUND INFORMATION

Modern vehicles with electronic brake pedals (ePedals or brake-by-wire) usually comprise redundant braking systems that comprise at least two braking products. For example, conventional braking systems may comprise, on the one hand, a BWA (by-wire actuation) as a first braking product and, on the other hand, an ESP (electronic stability program) as a second braking product. A braking command can be input by the driver or user of the vehicle by actuating the brake pedal. Redundant sensors in the brake pedal generate corresponding signals, which are forwarded via electrical lines to the first and second braking products. The braking products then perform the pressure build-up in the actual brake in order to carry out the desired braking.

In addition to the actual sensor data that describe the braking command, the sensors in the brake pedal also transmit calibration data that are used by the braking products in order to correctly interpret the braking command. While the sensor data of the at least two sensors are transmitted in each case redundantly to both braking products, each braking product only receives calibration data from one sensor. The, in each case, other calibration data are exchanged between the braking products via an existing bus system (e.g., CAN bus). For normal driving operation, it must therefore be ensured that the calibration data can be reliably exchanged between the individual braking products. This creates a dependence between the braking products as well as the need for bus communication between the braking products.

However, when manufacturing the vehicle or, for example, during vehicle maintenance, it cannot always be ensured that both braking products are present or active at the same time.

Germany Patent Application No. DE 10 2004 009 846 A1 describes a method for calibrating a pedal module of a motor vehicle, wherein a pedal of the pedal module can be moved by the action of a force.

Germany Patent Application No. DE 10 2010 006 087 A1 describes a target vehicle following control system that monitors a distance in relation to a target vehicle and a speed of the host vehicle.

Germany Patent Application No. DE 10 2014 224 234 B3 relates to a method for calibrating a signal generator device of a haptic accelerator pedal module for a motor vehicle and to a device for performing the method.

European Patent No. EP 3 962 763 B1 describes an adjustable accelerator pedal assembly.

### SUMMARY

An object of the present invention is to make operation of the braking system possible even if only one braking product is present or active in the vehicle. As a result, it is made possible, for example, to test individual braking products during the manufacture or maintenance of the vehicle.

Furthermore, e.g., (partially) autonomous driving of the vehicle between individual assembly locations in a factory hall or the like can be made possible during manufacture, even if only one braking product is installed or active.

According to a first aspect of the present invention, a method for operating a braking system in a vehicle is specified. According to a second aspect of the present invention, a braking system for a vehicle is provided. Further aspects of the present invention are disclosed herein.

A brake pedal of a braking system according to the present invention does not necessarily have to be a pedal operated by foot; rather, it can also be a lever or the like operated by hand. Within the meaning of the present invention, a brake pedal is a means for inputting a braking command that describes a desired braking effect. The braking command can be detected, for example, via pressure and/or a pedal position.

The brake pedal comprises at least two sensors that detect the braking command input by the user. By providing at least two sensors, the braking command can be detected redundantly. As a result, the reliability of the system and thus the safety required for driving operation on public roads can be ensured.

Each sensor can transmit calibration data to a braking product. The calibration data are used to interpret sensor data that the sensor generates when the brake pedal is actuated. The calibration data can comprise static (unchanging) calibration data and dynamic (changing) calibration data. The static calibration data usually depend on the sensor used and must be transmitted at least once when a braking product is first put into operation. The dynamic calibration data are preferably transmitted periodically, for example daily, hourly, every minute, every second, or several times per second. Dynamic calibration data may, for example, depend on temperature and/or humidity and/or service life of the brake or the like.

Calibration data can be presented in particular as a characteristic curve or characteristic map. By using calibration data, it can be ensured that the brake is actuated as desired and expected by the user according to the brake command.

When a user actuates the brake pedal, the sensors in each case generate sensor data that describe, in particular, a pressure on the brake pedal and/or a deflection of the brake pedal. Accordingly, the sensors can in each case comprise at least one pressure sensor and/or at least one displacement sensor.

The transmission of the first and second sensor data to the first braking product and/or to the second braking product is preferably carried out via separate and thus redundant communication lines and is carried out purely electrically or electronically. As a result, a reliable and secure data transmission that does not require any mechanical components to transmit the braking command can be ensured.

According to an example embodiment of the present invention, it is ascertained whether the first braking product and/or the second braking product is present in the vehicle. Here, a braking product is understood to be, e.g., an actuator having a control unit whose task is to interpret the braking command and to cause or control the build-up of a corresponding braking pressure on the brakes of the vehicle. A braking product includes in particular a BWA or an ESP. In this way, a safe, redundant brake-by-wire braking system can be realized.

If it is ascertained that the first braking product and the second braking product are present in the vehicle, the braking system is operated in a first operating state. The first operating state is the normal state, in which the vehicle can also be moved in road traffic. Whether the first and second braking products are present can be ascertained, for example, via a CAN bus or the like. Only if both braking products are present and ready for use can the vehicle be operated in the normal first operating state.

If it is ascertained that only the first braking product or only the second braking product is present in the vehicle, the braking system is operated in a second operating state. The second operating state can also be referred to as maintenance state, emergency mode, or production state. In this state, only one of the two braking products is installed or active in the vehicle and ready for operation. There is thus no redundant braking system. However, for testing purposes, for emergency operation under restricted boundary conditions or, e.g., for trips between assembly stations in a production facility, operation of the vehicle (e.g., for a short time) with only one braking product may also be permitted.

In particular during the manufacture and assembly of a vehicle, it may happen that only a first braking product is initially installed in the vehicle. In order to be able to test the braking product prior to installing or activating a second braking product, the braking system is set to the second operating state according to an example embodiment of the present invention. In this second operating state, the first braking product can be tested even without the calibration data of the second sensor. For this purpose, for example, specified calibration data for the second sensor can be stored on the first braking product, for example in a memory of a control unit of the first braking product. Furthermore, it may also be possible to interpret a braking command from the brake pedal only on the basis of the first sensor data and associated first calibration data.

According to a preferred configuration of the present invention, the first sensor or the second sensor can comprise a pressure sensor or a displacement sensor. Particularly preferably, the first sensor or the second sensor can comprise both a pressure sensor and a displacement sensor. The braking command can thus be generated using at least two independent sensors and measurement methods. The brake pedal can therefore be designed in particular as a pressure plate or a movable brake pedal so that either only a pressure, only a displacement or both pressure and displacement are detected by corresponding sensors.

The first braking product may preferably comprise an electronic stability program (ESP), and the second braking product may preferably comprise a by-wire actuator (BWA). According to an alternative embodiment, the first braking product may comprise the BWA and the second braking product may comprise the ESP.

According to an example embodiment of the present invention, the method further comprises: in the first operating state, exchanging the first and second calibration data between the first braking product and the second braking product via a bus system; and operating the first braking product and the second braking product, in each case according to the first and second calibration data and the sensor data.

Preferably, the first braking product can be operated in the second operating state according to the first calibration data and the sensor data. Further preferably, the first braking product can additionally be operated according to previously stored second calibration data. Thus, in the second operating state, communication with the second braking product for detecting and exchanging the second calibration data is not necessary. In this state, the braking system of the vehicle can be operated solely with the first braking product. In other words, the first braking product alone can build up and control the braking pressure for decelerating the vehicle. This is advantageous, for example, when testing the first braking product during the manufacture or maintenance of the vehicle.

Accordingly, the second braking product can conversely be operated according to the second calibration data and the sensor data, without the first calibration data being detected. Further preferably, the second braking product can additionally be operated according to previously stored first calibration data. Thus, in the second operating state, communication with the first braking product for detecting and exchanging the first calibration data is not necessary. In this state, the braking system of the vehicle can be operated solely with the second braking product. In other words, the second braking product alone can build up and control the braking pressure for decelerating the vehicle. This is advantageous, for example, when testing the second braking product during the manufacture or maintenance of the vehicle.

The first and second calibration data comprise, for example, static calibration data, which in particular describe unchanging hardware properties of the sensors, and/or dynamic calibration data, which in particular describe changing properties of the sensors.

Preferably, in the second operating state, a warning message can be issued to the user indicating to the user that the braking system is in the second operating state. This warning message can be displayed, for example, on an instrument cluster or infotainment system. The warning message can comprise acoustic and/or visual information.

Further preferably, operation of the vehicle in the second operating state can be restricted. For example, a maximum speed of the vehicle in the second operating state can be limited to a maximum value of, for example, 10 to 50 km/h, in particular 40 km/h, 30 km/h or 20 km/h. Furthermore, passenger transport can be prohibited in the second operating state by detecting whether persons are present in the passenger seats. These measures serve safety purposes since a redundant braking system may not be present in the second operating state.

If it is ascertained in the second operating state that the first braking product can communicate with the second braking product via a bus system, the braking system can be transferred to the first operating state. In other words, the bus system determines that two braking products are now present in the vehicle and ready for operation. The service or production mode can thus be exited again. The vehicle can be operated in the normal operating state again.

Preferably, in the first operating state, the user can input a control command in order to transfer the braking system from the first to the second operating state. Subsequently, the braking system can be operated in the second operating state. This can be carried out, for example, when servicing the braking system or during vehicle manufacture.

A braking system according to the present invention for a vehicle comprises a brake pedal for inputting a braking command by a user, a first sensor that is arranged on the brake pedal and generates first sensor data according to the braking command, a second sensor that is arranged on the brake pedal and generates second sensor data according to the braking command, and a first braking product and/or a second braking product, which are each communicatively connected to the first and second sensors. The braking system is configured to perform a method according to the present invention.

The present invention is explained in more detail below with reference to the exemplary embodiments indicated in the schematic figures.

### BRIEF DESCRIPTION OF THE DRAWINGS

FIG. 1 is a schematic top view of a braking system according to an exemplary embodiment of the present invention.

FIG. 2 shows an exemplary sequence of a method according to the present invention for operating a braking system according to an exemplary embodiment.

### DETAILED DESCRIPTION OF EXAMPLE EMBODIMENTS

The accompanying figures are intended to impart further understanding of the embodiments of the present invention. They illustrate embodiments and, in connection with the description, serve to explain principles and concepts of the present invention. Other embodiments and many of the mentioned advantages are apparent from the drawings. The elements of the drawings are not necessarily shown to scale relative to one another.

In the figures of the drawing, identical, functionally identical and identically acting elements, features and components are provided with the same reference signs in each case, unless otherwise stated.

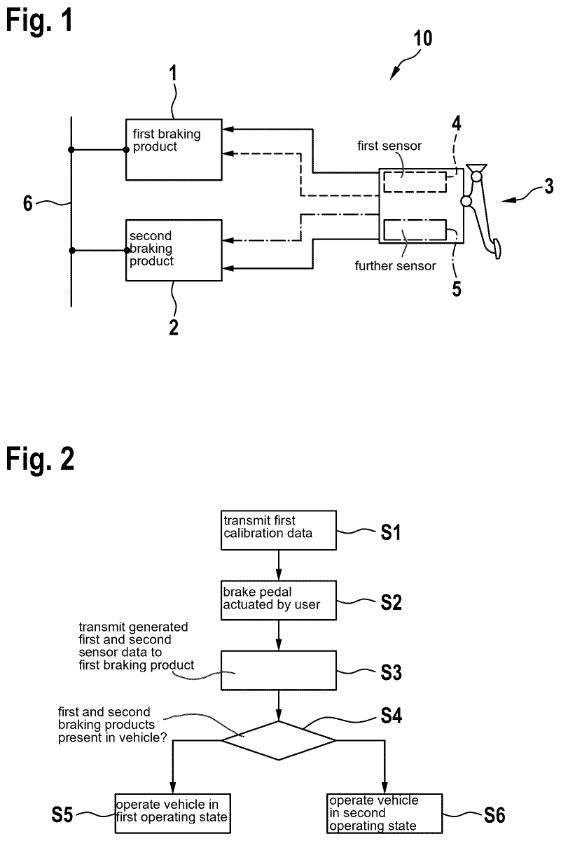

FIG. 1 is a schematic top view of a braking system 10 according to an exemplary embodiment of the present invention. The braking system 10 comprises a brake pedal 3 on which a first sensor 4 and a further sensor 5 are arranged. The sensors 4, 5 are communicatively connected via suitable lines to a first braking product 1, here for example a BWA, and a second braking product 2, here for example an ESP. The first and second braking products 1, 2 are communicatively connected to one another via an in-vehicle CAN bus system 6.

The first sensor 4 here is, for example, a pressure sensor. The second sensor 5 is, for example, a displacement sensor. When the brake pedal 3 is actuated, the two sensors 4, 5 in each case generate first and second sensor data, which in each case describe the pressure on the brake pedal 3 and the displacement of the brake pedal 3. The first and second sensor data are transmitted to both braking products 1, 2.

In addition, the sensors 4, 5 in each case transmit first and second calibration data, which each comprise static calibration data and dynamic calibration data. The first sensor 4 transmits its first calibration data only to the first braking product 1. The second sensor 5 transmits its second calibration data only to the second braking product 2. As a result, the required bandwidth for communication between the sensors 4, 5 and the braking products 1, 2 can be reduced.

The first braking product 1 and the second braking product 2 exchange the calibration data received from the sensors 4, 5 with one another via the CAN bus system 6 so that the first and second calibration data are available at both braking products 1, 2. Only if the first and second calibration data are available to both braking products 1, 2 can the braking system 10 generate the redundancy necessary for safety. Accordingly, the vehicle can only then be operated in the normal operating state. This operating state is referred to as the first operating state.

According to the present invention, the braking system 10 can also be operated in a second operating state, which can also be referred to as service mode or test mode. This second operating state can be used, for example, during the manufacture or maintenance of the vehicle. In the second operating state, only one of the two braking products 1, 2 is installed in the vehicle or ready for operation. Accordingly, no exchange of calibration data can take place via the CAN bus system 6.

In a first case, for example, during the manufacture of the vehicle, only the first braking product 1, the BWA, is initially installed in the vehicle. After installing the BWA, the function is to be tested prior to installing the ESP (second braking product 2). For this purpose, the braking system 10 can be set to the second operating state by a control command. Alternatively, a control unit of the braking system 10 can automatically recognize that only the first braking product 1 is installed, and can automatically assume the second operating state.

Since no communication with the second braking product 2 is possible, only the calibration data of the first sensor 4 are available to the first braking product 1. The sensor data of the second sensor 5 therefore cannot be interpreted using current calibration data. There is therefore no redundancy of the sensors. Typically, the control system of the vehicle would not permit driving operation. For example, in order nevertheless to make it possible to test the first braking system 1 or to drive to the next assembly station during manufacture, the second operating mode is used, which, e.g., makes driving at a limited speed possible (e.g., walking speed or a maximum of 10 to 20 km/h).

In order to use the second sensor data as well, the first braking product 1 can also use previously stored reference calibration data (static calibration data) for the second sensor 5. These can in particular be hardware-dependent. In this case, only the dynamic, i.e., changing, calibration data cannot be used. As soon as the braking system 10 recognizes that the second braking product 2 is also installed since, e.g., communication via the CAN bus system 6 between the braking products 1, 2 is possible, a change to the first operating state can be carried out automatically.

FIG. 2 shows an exemplary sequence of a method according to the present invention for operating a braking system 10 according to an exemplary embodiment. The method is described below for the above-mentioned case that only the first braking product 1 is installed in the vehicle.

In a first step S1, the first calibration data are transmitted from the first sensor 4 arranged on the brake pedal 3 of the vehicle to the first braking product 1. Transmitting the second calibration data from the second sensor 5 arranged on the brake pedal 3 to the second braking product 2 is not successful, since a second braking product 2 is not installed. This can be the case, for example, during the manufacture or maintenance of the vehicle.

Subsequently, the brake pedal 3 is actuated by a user in a step S2. In particular, the user depresses the brake pedal 3 with their foot so that pressure is exerted on the brake pedal 3 and the brake pedal 3 is deflected. The pressure and displacement of the brake pedal 3 are detected by the sensors 4, 5. Accordingly, in the second step S2, first and second sensor data are generated by the first and second sensors 4, 5 according to the actuation of the brake pedal 3 by the user.

The generated first and second sensor data are transmitted to the first braking product 1 in step S3.

In a step S4, which can also be carried out prior to the other steps, a control unit of the braking system 10 ascertains, for example, whether the first braking product 1 and the second braking product 2 are present in the vehicle. This step can also be carried out by the respective control units of the braking products 1, 2, for example by recognizing whether communication via the CAN bus system 6 with, in each case, the other braking product 1, 2 is possible or whether calibration data are received from, in each case, the other braking product 1, 2.

In the present example, the first braking product 1 ascertains in step S4 that no second calibration data are received from the second braking product 2. The second braking product 2 is either not installed, not ready for operation, or a fault is present in the CAN bus system 6. Subsequently, the braking system 10 is operated in the second operating state (step S6).

If the second braking product 2 is installed, or if communication between the braking products 1, 2 is established via the CAN bus system 6 and the calibration data are exchanged between the braking products 1, 2, it is recognized in S4 that operation in the first operating state (S5) is possible.

The method described above can be carried out periodically in order to monitor the state of the braking system 10 and to ensure that the braking system 10 is ready for operation. As a result, safe operation of the vehicle can be ensured.

Furthermore, it can be automatically recognized if, e.g., maintenance is being performed on the vehicle and only limited operation of the vehicle is to be made possible. The second operating state could also be made possible, in particular in the event of a vehicle breakdown, in order to make possible travel at reduced speed to a safe parking location.

In the present invention, multiple features have been designated “first” and “second.” These designations serve only to clearly distinguish the individual features. In particular, no spatial or functional arrangement or prioritization is to be derived therefrom.

When a list of alternatives in the present application is marked with the designation “or,” this is to be understood as meaning the listed alternatives taken individually but also, if appropriate, a combination of multiple or all of the listed alternatives.

1-11. (canceled)

12. A method for operating a braking system in a vehicle, comprising the following steps:
transmitting first calibration data from a first sensor arranged on a brake pedal of the vehicle to a first braking product and/or transmitting second calibration data from a second sensor arranged on the brake pedal of the vehicle to a second braking product;
generating first and second sensor data by the first and second sensors according to an actuation of the brake pedal by a user;
transmitting the first and second sensor data to the first braking product and/or to the second braking product;
ascertaining whether the first braking product and/or the second braking product is present in the vehicle;
based on ascertaining that the first braking product and the second braking product are both present in the vehicle, operating the braking system in a first operating state; and
based on ascertaining that only one of the first braking product and the second braking product is present in the vehicle, operating the braking system in a second operating state.

13. The method according to claim 12, wherein: (i) the first sensor includes a pressure sensor and/or a displacement sensor, and/or (ii) the second sensor includes a pressure sensor and/or a displacement sensor.

14. The method according to claim 12, wherein: (i) the first braking product includes an electronic stability program, and/or (ii) the second braking product includes a by-wire actuator.

15. The method according to claim 12, further comprising:
in the first operating state:
exchanging the first and second calibration data between the first braking product and the second braking product via a bus system, and
operating the first braking product and the second braking product, in each case according to the first and second calibration data and the sensor data.

16. The method according to claim 12, further comprising:
in the second operating state:
(i) operating the first braking product according to the first calibration data and the first sensor data, or (ii) operating the second braking product according to the second calibration data and the second sensor data.

17. The method according to claim 16, wherein:
(i) the first braking product is additionally operated according to previously stored second calibration data, or
(ii) the second braking product is additionally operated according to previously stored first calibration data.

18. The method according to claim 12, wherein the first and second calibration data include:
(i) static calibration data, which describe fixed hardware properties of the first and second sensors, and/or
(ii) dynamic calibration data, which describe changing properties of the first and second sensors.

19. The method according to claim 12, further comprising:
in the second operating state:
issuing a warning message to the user that the braking system is in the second operating state.

20. The method according to claim 12, further comprising:
based on ascertaining in the second operating state that the first braking product can communicate with the second braking product via a bus system, operating the braking system in the first operating state.

21. The method according to claim 12, further comprising:
in the first operating state:
inputting a control command by the user for transferring the braking system from the first to the second operating state; and
operating the braking system in the second operating state.

22. A braking system for a vehicle, comprising:
a brake pedal for inputting a braking command by a user;
a first sensor arranged on the brake pedal and configured to generate first sensor data according to the braking command;
a second sensor arranged on the brake pedal and configured to generate second sensor data according to the braking command; and
a first braking product and/or a second braking product, which are each communicatively connected to the first and second sensors;
wherein the braking system is configured to:
transmitting first calibration data from a first sensor arranged on a brake pedal of the vehicle to a first braking product and/or transmitting second calibration data from a second sensor arranged on the brake pedal of the vehicle to a second braking product,
generating first and second sensor data by the first and second sensors according to an actuation of the brake pedal by a user,
transmitting the first and second sensor data to the first braking product and/or to the second braking product,
ascertaining whether the first braking product and/or the second braking product is present in the vehicle,
based on ascertaining that the first braking product and the second braking product are both present in the vehicle, operating the braking system in a first operating state, and
based on ascertaining that only one of the first braking product and the second braking product is present in the vehicle, operating the braking system in a second operating state.
